(19) United States
(12) Patent Application Publication
(10) Pub. No.: US 2012/0105781 A1
(43) Pub. Date: May 3, 2012

(54) LIQUID CRYSTAL DISPLAY DEVICE AND MANUFACTURING METHOD THEREOF

(76) Inventors: Ah-Ram Lee, Yongin-si (KR); Kwan-Young Han, Yongin-si (KR); Eun-Young Lee, Yongin-si (KR)

(21) Appl. No.: 13/166,639

(22) Filed: Jun. 22, 2011

(30) Foreign Application Priority Data
Oct. 28, 2010 (KR) 10-2010-0106207

(51) Int. Cl. G02F 1/1337; H01J 9/24

(52) U.S. Cl. 349/123; 445/24

(57) ABSTRACT

An LCD device includes a substrate including a gate line, a data line, and a thin film transistor at a crossing region of the gate line and the data line, wherein the gate line and the data line define a pixel region, the LCD device also includes a pixel electrode, a common electrode separated from the pixel electrode, wherein the pixel electrode and the common electrode are alternately arranged in the pixel region, and an alignment layer on the pixel electrode and the common electrode, between the pixel electrode and the common electrode, and in a region adjacent to the pixel electrode, wherein the alignment layer has an upper surface having a substantially uniform height.

### CROSS-REFERENCE TO RELATED APPLICATION

This U.S. non-provisional patent application claims priority under 35 U.S.C.§119 to Korean Patent Application No. 10-2010-0106207 filed on Oct. 28, 2010, the entire contents of which are hereby incorporated by reference.

### BACKGROUND

1. Field

The present disclosure relates to a liquid crystal display (LCD) device and a manufacturing method thereof.

2. Description of Related Art

Liquid crystal cells in recent LCD devices typically operate in a twisted nematic, (TN) mode. Since the TN mode has characteristic where light transmittance varies in accordance with viewing angles in displaying gray levels, there are limitations in increasing the display area of the panels.

An in-plane-switching (IPS) mode, which uses a parallel electric field, enhances viewing angle characteristics such as contrast, gray level inversion, and color shift as compared to the TN mode.

The IPS mode is a mode where a pixel electrode and a common electrode are alternately formed in the same plane on a lower substrate including a thin film transistor (TFT), and liquid crystal is driven by a lateral electric field that is generated between the pixel electrode and the common electrode, which are formed on the same substrate.

### SUMMARY

Embodiments according to the present disclosure provide a liquid crystal display (LCD) device using an In-Plane-Switching (IPS) mode and a manufacturing method thereof, which remove the step difference of an alignment layer, thereby reducing or preventing light leakage due to a rubbing error.

Embodiments of the present invention provide a liquid crystal display (LCD) device including a substrate including a gate line, a data line, and a thin film transistor at a crossing region of the gate line and the data line, wherein the gate line and the data line define a pixel region, the LCD device also including a pixel electrode, a common electrode separated from the pixel electrode, wherein the pixel electrode and the common electrode are alternately arranged in the pixel region, and an alignment layer on the pixel electrode and the common electrode, between the pixel electrode and the common electrode, and in a region adjacent to the pixel electrode, wherein the alignment layer has an upper surface having a substantially uniform height.

Portions of the alignment layer between the pixel electrode and the common electrode and in the region adjacent to the pixel electrode may be thicker than a portion of the alignment layer on the pixel electrode and the common electrode.

A value equal to a sum of a thickness of the pixel electrode or the common electrode and a thickness of a portion of the alignment layer on the pixel electrode and the common electrode may be substantially the same as a thickness of portions of the alignment layer between the pixel electrode and the common electrode and in the region adjacent to the pixel electrode.

The alignment layer may include a first alignment layer including separated grooves, and a second alignment layer on the first alignment layer and the pixel electrode and the common electrode, wherein the pixel electrode and the common electrode are alternately placed in the grooves.

The first alignment layer may have a thickness substantially the same as the pixel electrode and the common electrode.

Embodiments of the present invention also provide a manufacturing method of a liquid crystal display (LCD) device, the manufacturing method including preparing a substrate including a gate line, a data line, and a thin film transistor at a crossing region of the gate line and data line, wherein the gate line and the data line define a pixel region, the manufacturing method also including forming a pixel electrode and a common electrode that are separated and alternately arranged in the pixel region, and forming an alignment layer on the pixel electrode and the common electrode, between the pixel electrode and the common electrode, and in a region adjacent to the pixel electrode, wherein the pixel electrode has an upper surface having a substantially uniform height.

The forming of the alignment layer may include forming an initial alignment layer on the pixel electrode and the common electrode, and planarizing the initial alignment layer.

The planarizing the initial alignment layer may include planarizing through exposure or etching.

The exposure may use an exposure mask including a transmission region for transmitting light, and a light shielding region for shielding light, the transmission region may correspond to a convex part of the initial alignment layer, and the light shielding region may correspond to a concave part of the initial alignment layer.

The etching may be performed using an etchback process.

The forming of the alignment layer may include forming a first alignment layer on the pixel electrode and the common electrode, planarizing the first alignment layer until the pixel electrode and the common electrode are exposed, and forming a second alignment layer on the exposed pixel electrode, the exposed common electrode, and the first alignment layer between the exposed pixel electrode and the exposed common electrode.

The planarizing the first alignment layer may include planarizing using exposure or etching.

The exposure may use an exposure mask including a transmission region for transmitting light, and one of a light shielding region for shielding light, or a semi-transmission region for partially transmitting light, the transmission region may correspond to a convex part of the first alignment layer, and the one of the light shielding region or the semi-transmission region may correspond to a concave part of the first alignment layer.

The etching may be performed using an etchback process.

Embodiments of the present invention further provided a manufacturing method of a liquid crystal display (LCD) device, the manufacturing method including preparing a substrate which includes a gate line, a data line, and a thin film transistor at a crossing region of the gate line and the data line defining a pixel region, the manufacturing method also including forming a first alignment layer on the substrate of the pixel region, the first alignment layer including separated grooves, forming a pixel electrode and a common electrode alternately in the grooves, planarizing the pixel electrode, the common electrode, and the first alignment layer, and forming a second alignment layer on the planarized pixel electrode, the planarized common electrode, and the planarized first alignment layer.

The grooves may be formed through exposure or etching, and may have a depth that is substantially the same as a thickness of the first alignment layer.

The pixel electrode and the common electrode may have a thickness that is substantially the same as a thickness of the first alignment layer.

### BRIEF DESCRIPTION OF THE DRAWINGS

The accompanying drawings are included to provide a further understanding of embodiments of the present invention, and are incorporated in, and constitute a part of, this application. The drawings illustrate exemplary embodiments of the present invention and, together with the description, serve to explain principles of the present invention. In the drawings:

FIG. 1 is a plan view illustrating an array substrate of a liquid crystal display (LCD) device using an In-Plane-Switching (IPS) mode according to first and second embodiments of the present invention;

FIG. 2 is a cross-sectional view taken along the lines I-I′ and II-II′ of FIG. 1, according to the first embodiment of the present invention;

FIG. 3 is a cross-sectional view taken along the lines I-I′ and II-II′ of FIG. 1, according to the second embodiment of the present invention;

FIGS. 4A to 4F and 5 are cross-sectional views illustrating a method for manufacturing an array substrate of an LCD device using an IPS mode according to an embodiment of the present invention;

FIGS. 6A to 6G and 7 are cross-sectional views illustrating a method for manufacturing an array substrate of an LCD device using an IPS mode according to another embodiment of the present invention; and

FIGS. 8A to 8F and 9 are cross-sectional views illustrating a method for manufacturing an array substrate of an LCD device using an IPS mode, according to yet another embodiment of the present invention.

### DETAILED DESCRIPTION

Exemplary embodiments of the present invention will be described below in more detail with reference to the accompanying drawings. The embodiments of the present invention may, however, be embodied in different forms and should not be construed as limited to the embodiments set forth herein. Rather, these embodiments are provided so that this disclosure will be thorough and complete, and will fully convey the scope of the present invention to those skilled in the art. In the drawings, therefore, the shapes and sizes of elements may be exaggerated for clarity. Like reference numerals in the drawings denote like elements.

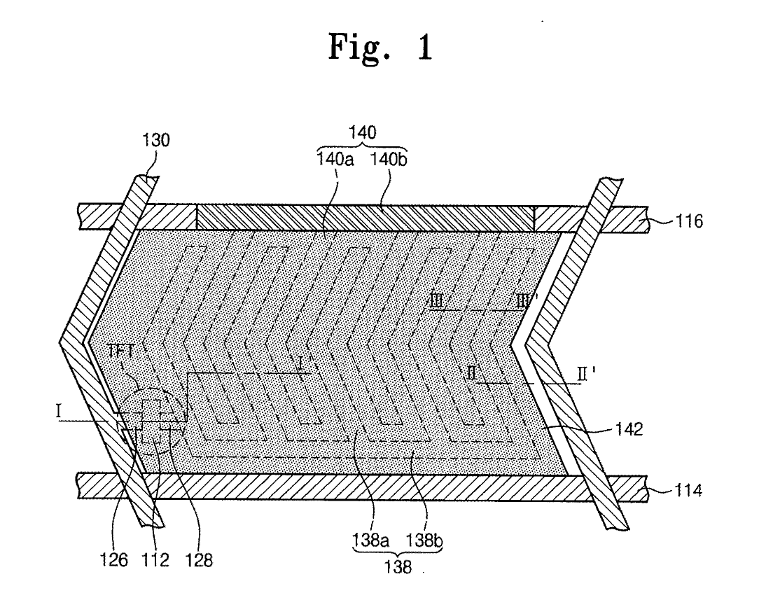

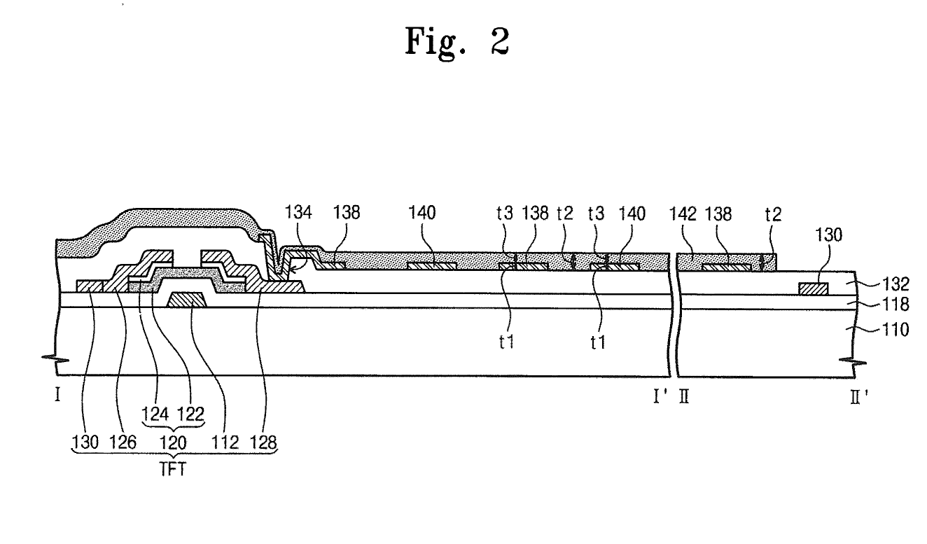

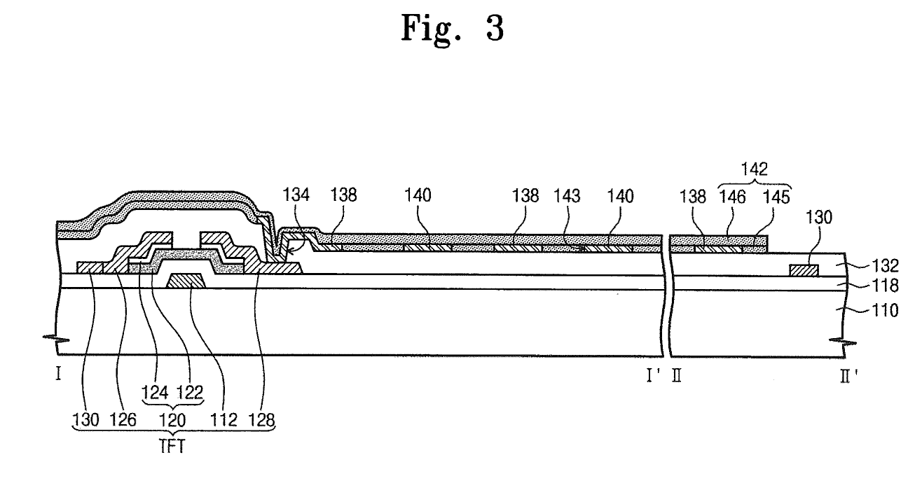

FIG. 1 is a plan view illustrating an array substrate of a liquid crystal display (LCD) device using an In-Plane-Switching (IPS) mode according to first and second embodiments of the present invention. FIG. 2 is a cross-sectional view taken along the lines I-I′ and II-II′ of FIG. 1 according to the first embodiment of the present invention. FIG. 3 is a cross-sectional view taken along the lines I-I′ and II-II′ of FIG. 1 according to the second embodiment of the present invention. In the first and second embodiments of the present invention, like reference numerals refer to like elements or similar elements.

Referring to FIGS. 1 and 2, an array substrate 100 of an LCD device using an IPS mode according to the first embodiment of the present invention may include a gate line 114 that is in parallel in one direction to be spaced a certain distance apart (e.g., from other lines), a common line 116 that is in one direction in parallel with the gate line 114, and a data line 130 that crosses the gate line 114 and the common line 116 and defines a pixel region (not shown) with the gate line 114. Herein, two or more gate lines 114 are in parallel to be separated (e.g., by a certain distance).

A thin film transistor TFT may be provided at a crossing region of the gate line 114 and the data line 130 (e.g., where the data line 130 crosses the gate line 114). Herein, the thin film transistor TFT includes a gate electrode 112, a semiconductor layer 120, and a source electrode 126 and a drain electrode 128 that are separated.

The source electrode 126 is coupled to the data line 130, and the gate electrode 112 is coupled to the gate line 114. The semiconductor layer 120 may include an active layer 122 and an ohmic contact layer 124. A gate dielectric 118 may be provided between the gate electrode 112 and the semiconductor layer 120. In this and other embodiments, a channel (not shown) may be provided in the exposed portion of the semiconductor layer 120.

A passivation layer 132 may be provided on the thin film transistor TFT and the data line 130.

A pixel electrode 138 and a common electrode 140 are provided on the passivation layer 132 of the pixel region. Herein, the pixel electrode 138 is coupled to the drain electrode 128 through a first contact hole 134, and the common electrode 140 is in parallel with the pixel electrode 138 and is coupled to the common line 116 through a second contact hole (not shown).

The pixel electrode 138 is extended from the drain electrode 128 and is formed in parallel with the data line 130. The pixel electrode 138 may include a plurality of vertical parts 138a that are spaced a certain distance apart, and a horizontal part 138b that is extended from the drain electrode 128 and couples the vertical parts 138a together.

The common electrode 140 is extended from the common line 116. The common electrode 140 may include a plurality of vertical parts 140a that are alternately provided in parallel with the vertical parts 138a of the pixel electrode 138, and a horizontal part 140b that couples the vertical parts 140a together.

That is, the pixel electrode 138 and the common electrode 140 may be alternately arranged to be separated. The pixel electrode 138 and the common electrode 140 may have a first thickness t1 and may be formed of the same material on the same plane. The pixel electrode 138 and the common electrode 140 may be formed of a transparent conductive material, for example, indium tin oxide (ITO).

An alignment layer 142 may be provided over the substrate 110 including the pixel electrode 138 and the common electrode 140.

A portion of the alignment layer 142 that is formed between the pixel electrode 138 and the common electrode 140 and formed in a region adjacent to the pixel electrode 138 may be thicker than another portion of the alignment layer 142 that is formed on the pixel electrode 138 and the common electrode 140. Accordingly, the alignment layer 142 may have an upper surface having the same height (e.g., a substantially uniform height) on the pixel electrode 138 and common electrode 140, between the pixel electrode 138 and common electrode 140, and in the region adjacent to the pixel electrode 138 (e.g., the upper surface may be planarized).

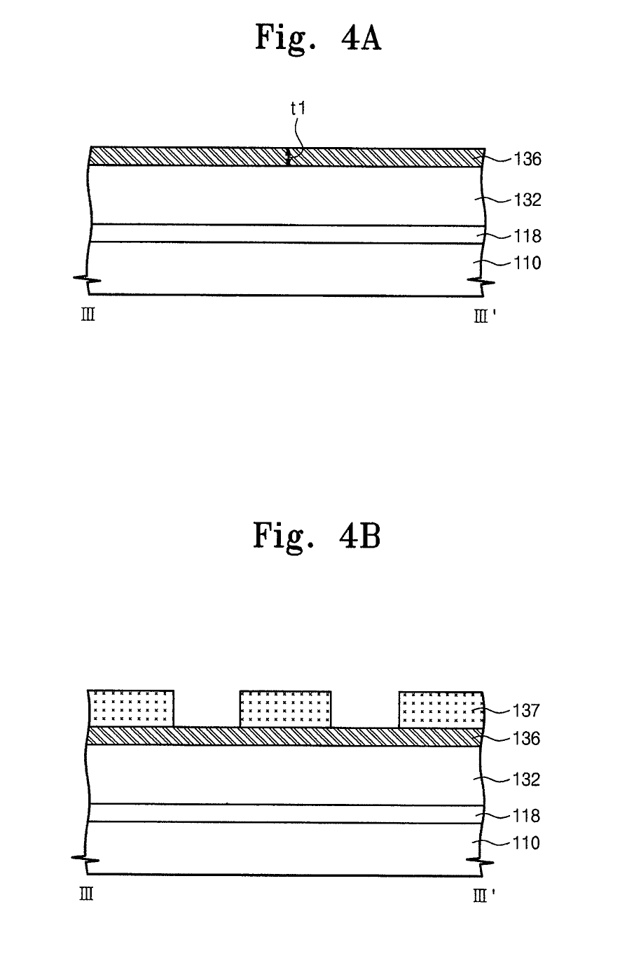

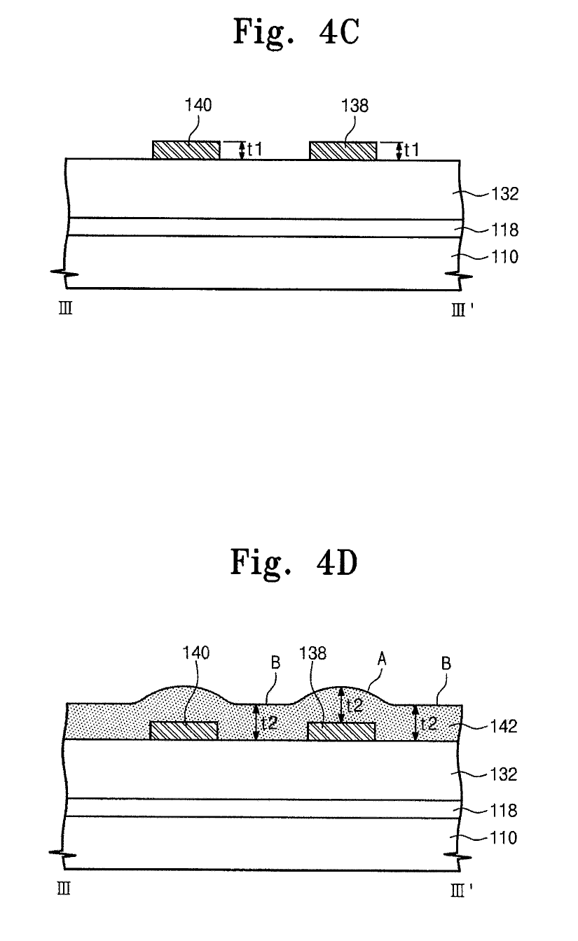

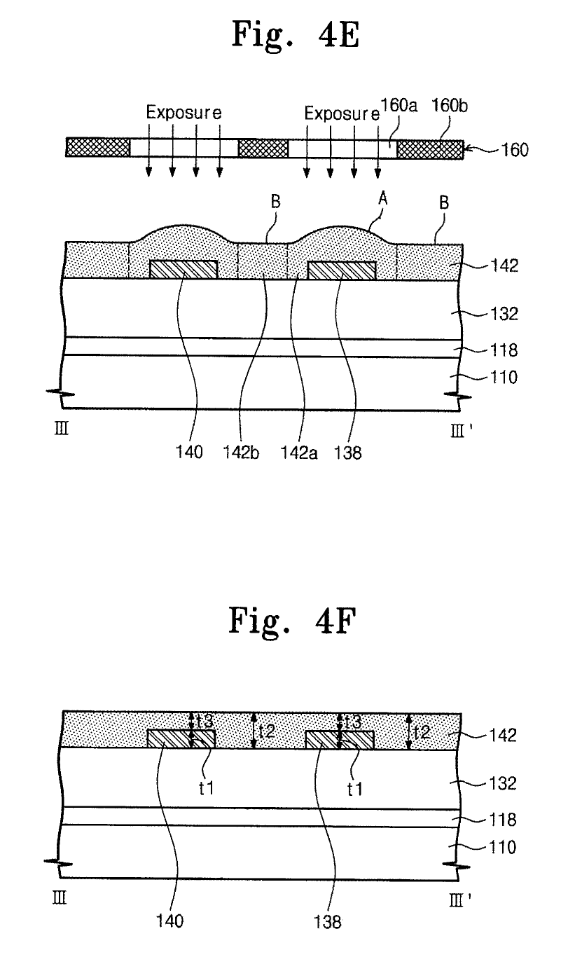

The sum of the thickness t1 and a thickness t3 (shown in FIG. 4F) may be substantially the same as a thickness t2 (shown in FIGS. 4D and 4F). Herein, the thickness t1 is that of the pixel electrode 138 or the common electrode 140, the thickness t3 is that of the alignment layer 142 on the pixel electrode 138 and the common electrode 140, and the thickness t2 is that of the alignment layer 142 in a region between the pixel electrode 138 and the common electrode 140 and in a region adjacent to the pixel electrode 138.

The alignment layer 142 may be formed of resin, for example, polyimide having excellent affinity with liquid crystal.

Referring to FIG. 3, an array substrate 100 of an LCD device using an IPS mode according to the second embodiment of the present invention may include an alignment layer 142 that is formed in a structure where first and second alignment layers 145 and 146 are stacked, and may be substantially the same as the first embodiment of the present invention, except for that a pixel electrode 138 and a common electrode 140 are respectively provided in grooves 143 of the first alignment layer 145. In description of the second embodiment, therefore, repetitive description of the same elements as those of the first embodiment of the present invention will be omitted, and only differences will be described below in detail.

The alignment layer 142 may include the first alignment layer 145 including the grooves 143, and the second alignment layer 146 provided on the first alignment layer 145 (e.g., on the first alignment layer 145, the pixel electrode 138, and the common electrode 140). The first alignment layer 145 may be provided on the passivation layer 132. The pixel electrode 138 and common electrode 140, which are provided in the grooves 143 of the first alignment layer 145, may have upper surfaces in the same plane as the upper surface of the first alignment layer 145.

The first alignment layer 145 may be formed to have substantially the same thickness as that of the pixel electrode 138 and the common electrode 140. The depth of each of the grooves 143 may be about the same as the thickness of the first alignment layer 145.

The second alignment layer 146 may be provided on the pixel electrode 138, the common electrode 140, and the first alignment layer 145 without a step difference. Accordingly, the second alignment layer 142 having no step difference may be provided.

The first and second alignment layers 145 and 146 may be formed of resin, for example, polyimide having excellent affinity with liquid crystal.

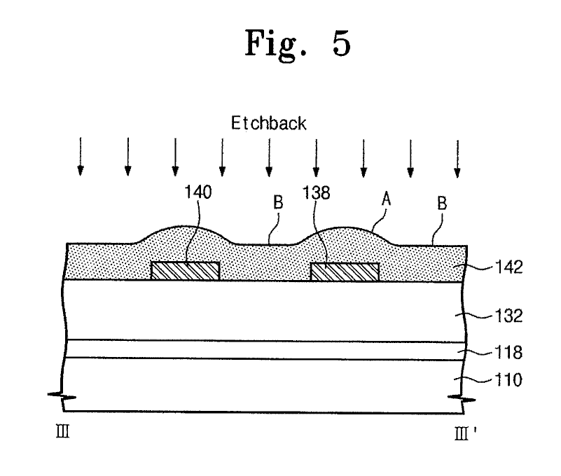

Hereinafter, a method for manufacturing an array substrate of an LCD device using an IPS mode according to an embodiment of the present invention will be described in detail with reference to FIGS. 4A to 4F and 5.

FIGS. 4A to 4F and 5 are cross-sectional views illustrating a method for manufacturing an array substrate of an LCD device using an IPS mode, according to an embodiment of the present invention.

Referring to FIG. 4A, a substrate 110 on which a gate dielectric 118 and a passivation layer 132 are sequentially stacked is prepared.

Although not shown in FIGS. 4A to 4F and 5, gate lines 114, data lines 130, thin film transistors TFTs, and common lines 116 (see FIG. 1) may be included below the passivation layer 132. Herein, the gate lines 114 cross the data lines 130, the thin film transistors TFTs are respectively provided at the crossing regions of the gate lines 114 and the data lines 130, and the common lines 116 are provided in parallel with the gate lines 114. A gate electrode 112, a semiconductor layer 120, a source electrode 126, and a drain electrode 128 may be included in the thin film transistor TFT (see FIG. 3), wherein the source electrode 126 and the drain electrode 128 are separated. The gate dielectric 118 may be provided between the gate electrode 112 and the semiconductor layer 120. A first contact hole 134 for exposing a portion of the drain electrode 128 and a second contact hole for exposing a portion of the common line 116 may be included in the passivation layer 132. Such elements may be formed through a known technology, and description of the formation technology will be omitted.

A conductive layer 136 having a first thickness t1 is formed on the passivation layer 132. The conductive layer 136 is formed to the thicknesses of a pixel electrode 138 and a common electrode 140 (see FIG. 4C) that will be formed subsequently.

For example, the conductive layer 136 may be formed of ITO. The conductive layer 136 may be formed using a physical vapor deposition (PVD) method, for example, a sputtering method.

Referring to FIG. 4B, a photoresist pattern 137 is formed on the conductive layer 136. A photoresist film (not shown) is formed by coating a photosensitive material on the conductive layer 136, and thereafter, the photoresist pattern 137 may be formed by exposing and developing the photoresist film with a mask (not shown). A positive or negative photosensitive material may be used as the photosensitive material.

Referring to FIG. 4C, the conductive layer 136 (see FIG. 4B) is etched using the photoresist pattern 137 as an etching mask.

Dry etching or wet etching may be performed during the etching process. For example, plasma etching or reactive ion etching may be performed for dry etching. Therefore, the pixel electrode 138 and the common electrode 140 having the first thickness t1 may be formed.

The pixel electrode 138 and the common electrode 140 are separated in parallel, and may be formed to be alternately arranged.

The pixel electrode 138 is extended from the drain electrode 128 and is parallel with the data line 130. The pixel electrode 138 may include a plurality of vertical parts 138a that are spaced a certain distance apart, and a horizontal part 138b that is extended from the drain electrode 128 and coupled to the vertical parts 138a together (see FIG. 1). Herein, the pixel electrode 138 indicates the vertical parts 138a.

The common electrode 140 is extended from the common line 116, and may include a plurality of vertical parts 140a that are arranged alternately and in parallel with the vertical parts 138a of the pixel electrode 138, and a horizontal part 140b that couples the vertical parts 140a together (see FIG. 1). Herein, the common electrode 140 indicates the vertical parts 140a.

The pixel electrode 138 is coupled to the drain electrode 128 through the first contact hole 134, and the common electrode 140 is coupled to the common line 116 through the second contact hole.

Subsequently, the photoresist pattern 137 is removed.

Referring to FIG. 4D, an alignment layer 142 is formed on the pixel electrode 138 and the common electrode 140. Resin such as polyimide is printed on the substrate 110 including the pixel electrode 138 and the common electrode 140 and is dried, and thereby the alignment layer 142 is formed.

The alignment layer 142 conformally has a second thickness t2 between the pixel electrode 138 and the common electrode 140, in a region adjacent to the pixel electrode 138, on the pixel electrode 138, and on the common electrode 140. The alignment layer 142 has a convex part A on the pixel electrode 138 and on the common electrode 140. The alignment layer 142 has a concave part B between the pixel electrode 138 and the common electrode 140, and in the region adjacent to the pixel electrode 138. That is, the alignment layer 142 has a step difference due to the pixel electrode 138 and the common electrode 140.

Referring to FIG. 4C, an exposure mask 160 is placed on the alignment layer 142 (see FIG. 4D and 4E). The exposure mask 160 may include a transmission region 160a that transmits light, and a light shielding region 160b that shields light. In this case, the transmission region 160a corresponds with the convex part A of the alignment layer 142 (see FIG. 4D), and the light shielding region 160b corresponds with the concave part B of the alignment layer 142 (see FIG. 4D).

The alignment layer 142 (see FIG. 4D) is exposed with the exposure mask 160. Such an exposure process may be performed by irradiating ultraviolet (UV) light. An exposure time or an exposure intensity may be controlled in order for the alignment layer 142 to be planarized.

At this point, among the exposed portions of the alignment layer 142, the convex part A corresponding to the transmission region 160a is formed as an exposure part 142a through irradiation of light, and the concave part B corresponding to the light shielding region 160b is formed as a non-exposure part 142b through shielding of light (see FIG. 4E). After the exposure, the exposure mask 160 is removed.

Referring to FIG. 4F, the exposed alignment layer 142 (see FIG. 4E) is developed. As the exposure part 142a (see FIG. 4E) is etched by a certain thickness and the convex part A (see FIG. 4E) is removed, the thickness t3 of the alignment layer 142 that remains on the pixel electrode 138 and common electrode 140 becomes thinner than an initial deposition thickness t2, and the alignment layer 142 of the non-exposure part 142b (see FIG. 4E) maintains the initial deposition thickness t2, and the alignment layer 142 is planarized.

That is, the sum of the thickness t1 and the thickness t3 may be substantially the same as the thickness t2. Herein, the thickness t1 is that of the pixel electrode 138 or the common electrode 140, the thickness t3 is that of the alignment layer 142 on the pixel electrode 138 and the common electrode 140, and the thickness t2 is that of the alignment layer 142 between the pixel electrode 138 and the common electrode 140 and in a region adjacent to the pixel electrode 138.

Therefore, the planarized alignment layer 142 may have an upper surface having substantially the same height (e.g., a substantially uniform height) between the pixel electrode 138 and common electrode 140, in the region adjacent to the pixel electrode 138, and on the pixel electrode 138 and common electrode 140.

In the manufacturing method according to the present embodiment, by moderating or removing the step difference of the alignment layer 142 that has initially been deposited through exposure and etching, the planarized alignment layer 142 is formed. Accordingly, the manufacturing method improves a rubbing error in a subsequent rubbing process, enhances the uniformity of alignment through the improvement, and thus reduces or prevents light leakage, thereby realizing an LCD device having a high image quality.

The manufacturing method according to the present embodiment forms the planarized alignment layer 142 by removing (e.g., planarizing) the convex part A of the alignment layer 142 through the exposure, but it is not limited thereto.

As an example, as illustrated in FIG. 5, the planarized alignment layer 142 of FIG. 4F may be formed by removing the convex part A of the alignment layer 142 through etching. Herein, etching may be performed using dry etching, for example, an etchback process using plasma. The etchback process may use, for example, O₂ gas and SF₆ gas as an etching gas. Using the etchback process, the second exposure mask 160 and the development process can be omitted. Accordingly, the number of masks is reduced, a process is simplified, and cost is reduced.

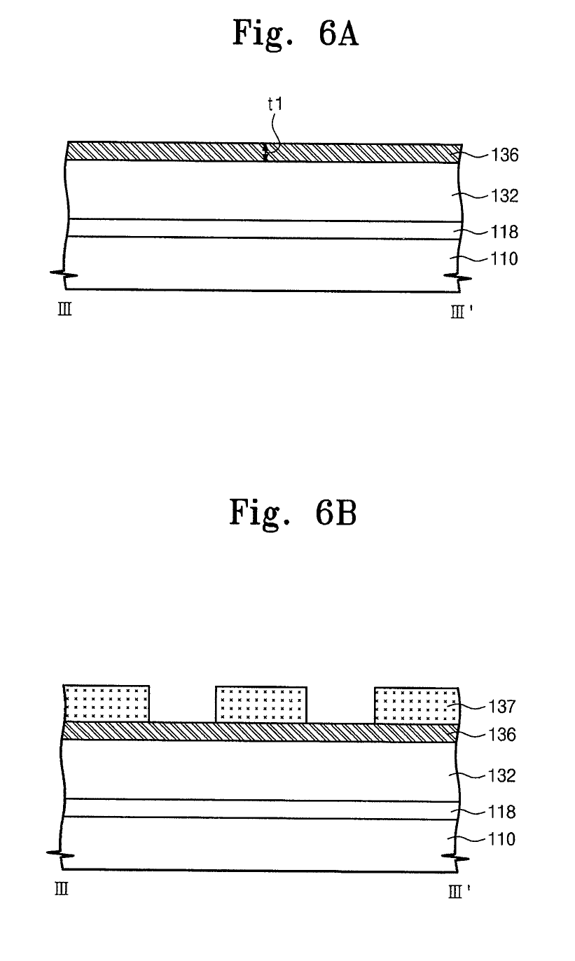

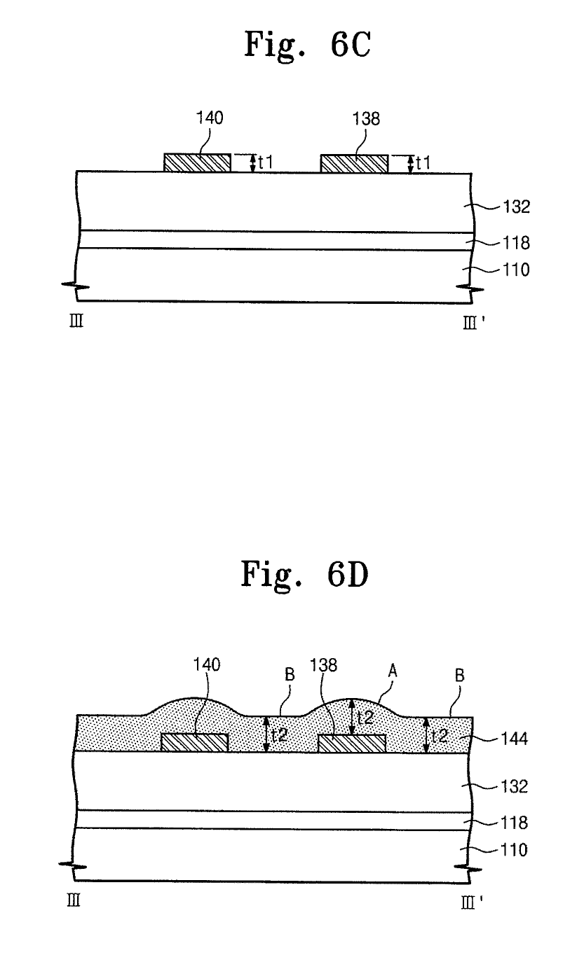

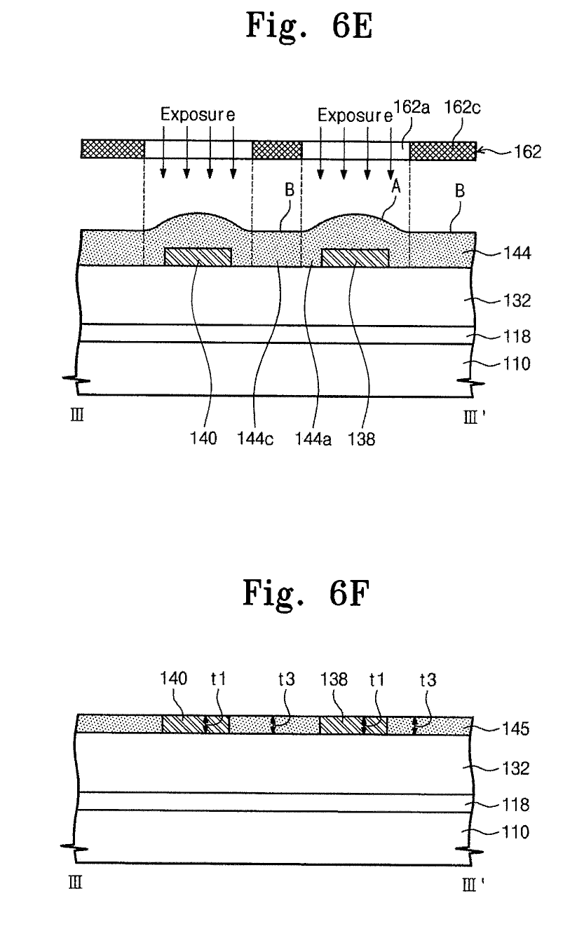

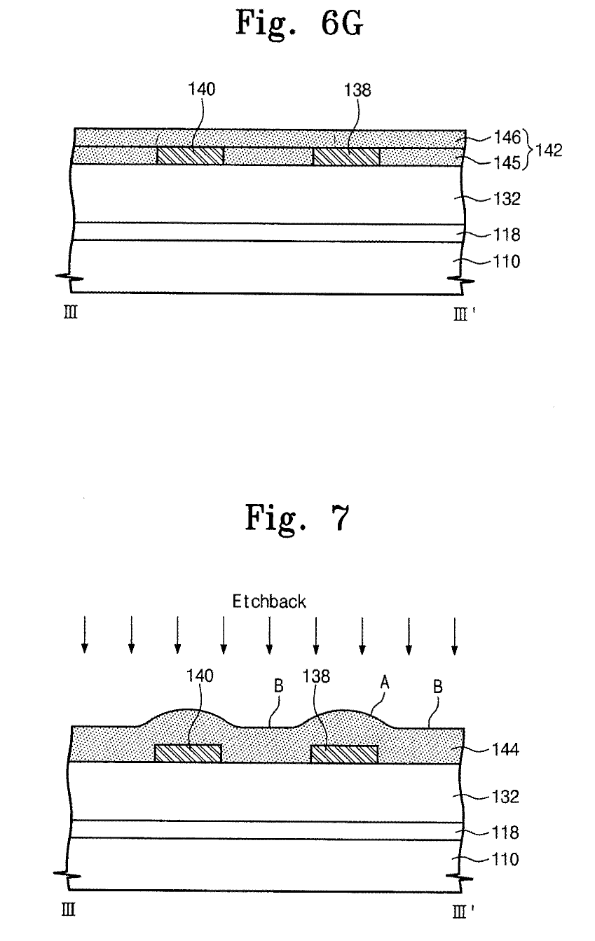

Hereinafter, a method for manufacturing an array substrate of an LCD device using an IPS mode according to another embodiment of the present invention will be described in detail with reference to FIGS. 6A to 6G and 7.

FIGS. 6A to 6G and 7 are cross-sectional views illustrating a method for manufacturing an array substrate of an LCD device using an IPS mode, according to the present embodiment. The manufacturing method of FIGS. 6A to 6C may be substantially the same as that of FIGS. 4A to 4C, and thus overlapping description will be omitted. The following description will be made in reference to FIG. 6D. Herein, like reference numerals refer to like elements or similar elements.

Referring to 6D, a first alignment layer 144 having a second thickness t2 is formed on a pixel electrode 138 and a common electrode 140 that have a first thickness t1 (see FIG. 6C). Resin such as polyimide is printed on the substrate 110 including the pixel electrode 138 and the common electrode 140, and is then dried, and thereby the first alignment layer 144 is formed.

The first alignment layer 144 conformally has the second thickness t2 between the pixel electrode 138 and the common electrode 140, in a region adjacent to the pixel electrode 138, on the pixel electrode 138, and on the common electrode 140. The first alignment layer 144 has a convex part A on the pixel electrode 138 and the common electrode 140. The first alignment layer 144 has a concave part B between the pixel electrode 138 and the common electrode 140, and in the region adjacent to the pixel electrode 138. That is, the first alignment layer 144 has a step difference due to the pixel electrode 138 and the common electrode 140.

Referring to FIG. 6E, an exposure mask 162 is placed on the first alignment layer 144 (see FIG. 6D). The exposure mask 162 may include a transmission region 162a that transmits light, and a semi-transmission region 162c that transmits a portion of light and shields another portion of light. The exposure mask 162 may be a halftone mask. When intending to leave the first alignment layer 144 (see FIG. 6D) of one region, the exposure mask 162 may include the transmission region 162a instead of the semi-transmission region 162c.

In this case, the transmission region 162a corresponds with the convex part A of the first alignment layer 144 (see FIG. 6D), and the semi-transmission region 162c corresponds with the concave part B of the first alignment layer 144 (see FIG. 6D).

The first alignment layer 144 (see FIG. 6D) is exposed with the exposure mask 162. Such an exposure process may be performed by irradiating UV light. An exposure time or an exposure intensity may be controlled for causing the upper surface of the remaining first alignment layer 144 (e.g., the remaining portions of the first alignment layer 144) (see FIG. 6D) and the upper surfaces of the pixel electrode 138 and common electrode 140 to be in the same plane.

At this point, among the exposed portions of the first alignment layer 144, the convex part A corresponding to the transmission region 162a is formed as an exposure part 144a through irradiation of light, and the concave part B corresponding to the semi-transmission region 162c is formed as a non-exposure part 144b by irradiating a portion of light. After the exposure, the exposure mask 162 is removed.

Referring to FIG. 6F, the exposed alignment layer 144 (see FIG. 6E) is developed. As the exposure part 144a (see FIG. 6E) is etched and the convex part A (see FIG. 6E) is removed, the upper surfaces of the pixel electrode 138 and common electrode 140 are exposed, and the non-exposure part 144b (see FIG. 6E) may be planarized by being etched to an amount less than the etching amount of the exposure part 144a (see FIG. 6E).

The remaining first alignment layer 145 (e.g., the remaining portions of the first alignment layer 144) between the pixel electrode 138 and the common electrode 140 and in a region adjacent to the pixel electrode 138, may have a third thickness t3 thinner than the second thickness t2. The remaining first alignment layer 145 may have substantially the same thickness as that of the pixel electrode 138 and the common electrode 140.

Accordingly, the upper surface of the pixel electrode 138, the upper surface of the common electrode 140, and the upper surface of the remaining first alignment layer 145 have the same height (e.g., a substantially uniform height). A step difference does not exist between the pixel electrode 138 and common electrode 140 and the remaining first alignment layer 145. That is, the remaining first alignment layer 145 may be formed by being planarized together with the pixel electrode 138 and the common electrode 140.

Referring to FIG. 6G, a second alignment layer 146 is formed on the pixel electrode 138, the common electrode 140, and the remaining first alignment layer 145. Resin such as polyimide is printed on the pixel electrode 138, the common electrode 140, and the remaining first alignment layer 145, and is dried, and thereby the second alignment layer 146 is formed.

The second alignment layer 146 may have a substantially uniform thickness on the pixel electrode 138, on the common electrode 140, between the pixel electrode 138 and common electrode 140, and on the remaining first alignment layer 145 of a region adjacent to the pixel electrode 138. Accordingly, the second alignment layer 146 can be planarized and provided without a step difference.

The remaining first alignment layer 145 and the second alignment layer 146 configure (e.g., together form) an alignment layer 142. Accordingly, the alignment layer 142 can be planarized and formed without a step difference.

In the manufacturing method according to the present embodiment, the upper surface of the pixel electrode 138, the upper surface of the common electrode 140, and the upper surface of the remaining first alignment layer 145 are formed to have the same height (e.g., a substantially uniform height) by etching the first alignment layer 144 through exposure and etching, and thereafter the second alignment layer 146 is formed on the pixel electrode 138, the common electrode 140, and the remaining first alignment layer 145. Therefore, the alignment layer 142 having no step difference may be formed through planarization of the second alignment layer 146 (e.g., a planarized second alignment layer 146). Accordingly, the manufacturing method improves a rubbing error and thus reduces or prevents light leakage, thereby realizing an LCD device having a high image quality.

In the manufacturing method according to another embodiment of the present invention, the upper surface of the pixel electrode 138, the upper surface of the common electrode 140, and the upper surface of the remaining first alignment layer 145 are placed on the same plane by etching the first alignment layer 144 by a desired thickness for each region through the exposure, but they are not limited thereto.

As an example, as illustrated in FIG. 7, by etching the first alignment layer 144 by a desired thickness for each region through the exposure, the upper surface of the pixel electrode 138, the upper surface of the common electrode 140, and the upper surface of the remaining first alignment layer 145 may be placed on the same plane as illustrated in FIG. 6F. Herein, etching may be performed using dry etching, for example, an etchback process using plasma. The etchback process may use, for example, O₂ gas and SF₆ gas as an etching gas. Using the etchback process, the exposure mask 162 and the development process may be omitted. Accordingly, the number of masks is reduced, a process is simplified, and cost is reduced.

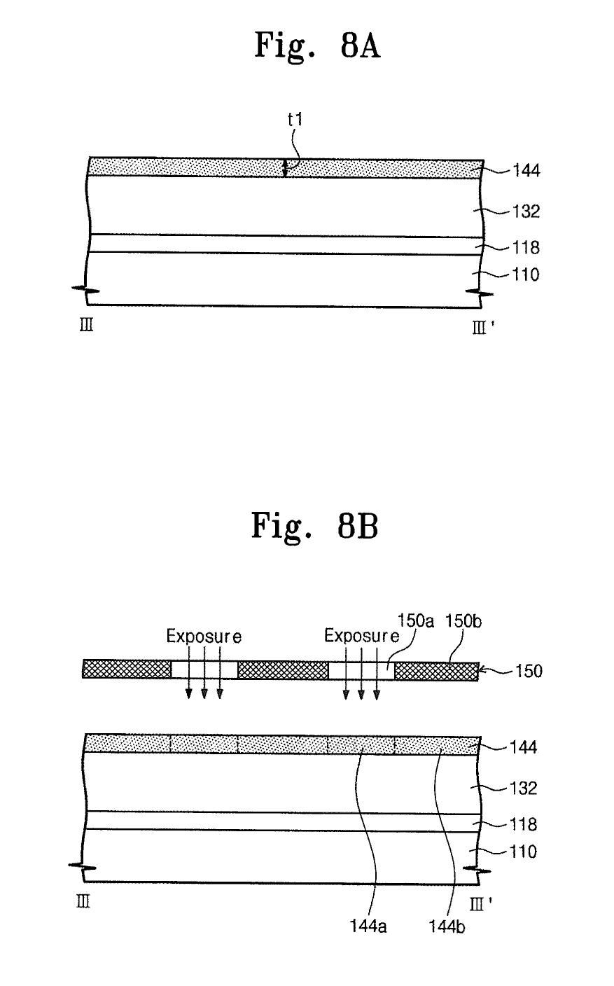

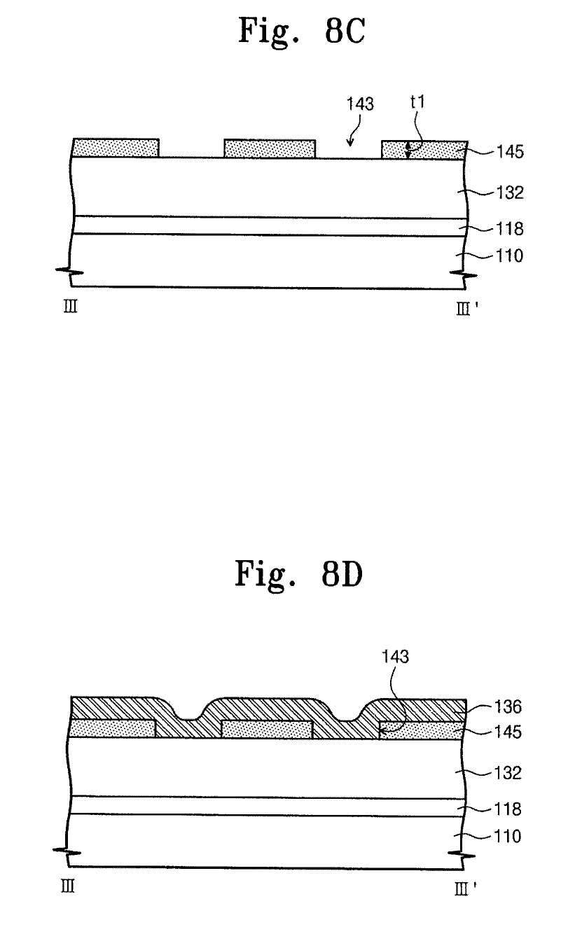

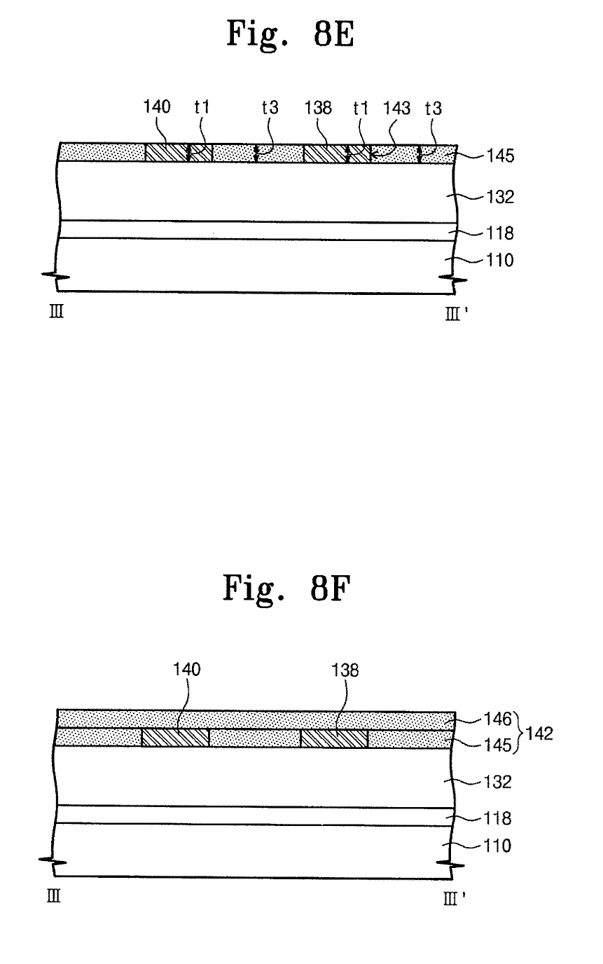

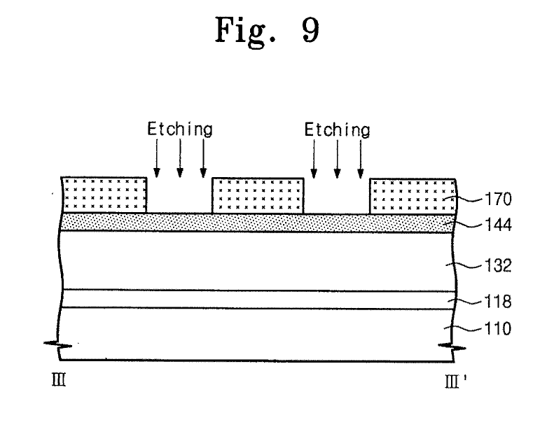

Hereinafter, a method for manufacturing an array substrate of an LCD device using an IPS mode according to a third embodiment of the present invention will be described in detail with reference to FIGS. 8A to 8F and 9.

FIGS. 8A to 8F and 9 are cross-sectional views illustrating a method for manufacturing an array substrate of an LCD device using an IPS mode according to yet another embodiment of the present invention. Herein, like reference numerals refer to like elements or similar elements.

Referring to FIG. 8A, a substrate 110 on which a gate dielectric 118 and a passivation layer 132 are sequentially stacked is prepared.

Although not shown in FIGS. 8A to 8F and 9, gate lines 114, data lines 130, thin film transistors and common lines 116 may be included in the passivation layer 132. Herein, the gate lines 114 cross the data lines 130, the thin film transistors TFTs are respectively provided in the crossing regions of the gate lines 114 and the data lines 130, and the common lines 116 are provided in parallel with the gate lines 114. A gate electrode 112, a semiconductor layer 120, a source electrode 126, and a drain electrode 128 may be included in the thin film transistor TFT, wherein the source electrode 126 and the drain electrode 128 are separated. The gate dielectric 118 may be provided between the gate electrode 112 and the semiconductor layer 120. A first contact hole 134 for exposing a portion of the drain electrode 128, and a second contact hole for exposing a portion of the common line 116, may be included in the passivation layer 132. Such elements may be formed through a known technology (e.g., known to one skilled in the art), and description on this will be omitted.

A first alignment layer 144 having a first thickness t1 is formed on the passivation layer 132. The first alignment layer 144 is formed to the thicknesses of a pixel electrode 138 and a common electrode 140 (see FIG. 8E) that will be formed subsequently.

Resin such as polyimide is printed on the passivation layer 132 and is dried, and thereby the first alignment layer 144 is formed. The first alignment layer 144 may be formed to substantially the same thicknesses as that of the subsequently formed pixel electrode 138 and common electrode 140 (see FIG. 8E).

Referring to FIG. 8B, an exposure mask 150 is placed on the first alignment layer 144 (see FIG. 8A). The exposure mask 150 may include a transmission region 150a that transmits light, and a light shielding region 150b that shields light.

The first alignment layer 144 (see FIG. 8A) is selectively exposed using the exposure mask 150. Such an exposure process may be performed by irradiating UV light. At this point, among the exposed portions of the first alignment layer 144, the first alignment layer 144 (see FIG. 8A) corresponding to the transmission region 150a is formed as an exposure part 144a due to irradiation of light, and the first alignment layer 144 (see FIG. 8A) corresponding to the light shielding region 150b is formed as a non-exposure part 144b due to shielding of light. After the exposure, the exposure mask 150 is removed.

Referring to FIG. 8C, the exposed first alignment layer 144 (see FIG. 8B) is developed. At this point, the exposure part 144a (see FIG. 8B) is etched, and thereby, grooves 143 are formed. The non-exposure part 144b (see FIG. 8B) remains and is formed as a remaining first alignment layer 145 having the first thickness t1. Herein, the grooves 143 may be formed to have the same depth as the thickness t1 of the remaining first alignment layer 145.

Referring to FIG. 8D, a conductive layer 136 is formed on, or in, the grooves 143 and on the remaining first alignment layer 145. For example, the conductive layer 136 may be formed of ITO. The conductive layer 136 may be formed using a PVD method, for example, a sputtering method.

Referring to FIG. 8E, the conductive layer 136 (see FIG. 8D) is planarized. Such a planarization process may be performed using an etchback process or a chemical mechanical polishing (CMP) process. The planarization process may be performed using the remaining first alignment layer 145 as an etch stop layer.

Therefore, the conductive layer 136 (see FIG. 8D) remains inside the grooves 143, and thus, a pixel electrode 138 and a common electrode 140 are formed. The pixel electrode 138 and the common electrode 140 may be separated in parallel and arranged alternately.

Also referring to FIG. 1 the pixel electrode 138 is extended from the drain electrode 128 and is formed in parallel with the data line 130. The pixel electrode 138 may include a plurality of vertical parts 138a that are spaced a certain distance apart, and a horizontal part 138b that is extended from the drain electrode 128 and couples the vertical parts 138a together. Herein, the pixel electrode 138 indicates the vertical parts 138a.

The common electrode 140 is extended from the common line 116. The common electrode 140 may include a plurality of vertical parts 140a that are alternately provided in parallel with the vertical parts 138a of the pixel electrode 138, and a horizontal part 140b that couples the vertical parts 140a together. Herein, the common electrode 140 indicates the vertical parts 140a.

The pixel electrode 138 is coupled to the drain electrode 128 through a first contact hole 134, and the common electrode 140 is coupled to the common line 116 through a second contact hole.

In the above description, the pixel electrode 138 and the common electrode 140 have a thickness t1, and the remaining first alignment layer 145 has a thickness t3. The upper surface of the pixel electrode 138, the upper surface of the common electrode 140, and the upper surface of the remaining first alignment layer 145 have the same height (e.g., are planarized). A step difference does not exist between the pixel electrode 138, the common electrode 140, and the remaining first alignment layer 145.

In the present embodiment, a process called a damascene process forms the grooves 143, deposits the conductive layer 136, and forms the pixel electrode 138 and the common electrode 140 by patterning the conductive layer 136.

Referring to FIG. 8F, a second alignment layer 146 is formed on the pixel electrode 138, the common electrode 140, and the remaining first alignment layer 145. Resin such as polyimide is printed on the pixel electrode 138, the common electrode 140, and the remaining first alignment layer 145, and is then dried, and thereby the second alignment layer 146 is formed.

The second alignment layer 146 has a substantially uniform thickness on the pixel electrode 138 and the common electrode 140 and on the remaining first alignment layer 145 adjacent to the pixel electrode 138. Accordingly, the second alignment layer 146 can be planarized and formed without a step difference.

Herein, the remaining first alignment layer 145 and the second alignment layer 146 configure an alignment layer 142. Accordingly, the alignment layer 142 can be planarized and formed without a step difference.

In the manufacturing method according to the present embodiment, the grooves 143 are formed in the first alignment layer 144 through exposure or etching. Subsequently, the upper surface of the remaining first alignment layer 145, the upper surface of the pixel electrode 138, and the upper surface of the common electrode 140 are formed to have the same height (e.g., a substantially uniform height) through the damascene process, and thereafter the second alignment layer 146 is formed on the remaining first alignment layer 145, the pixel electrode 138, and the common electrode 140. Therefore, the alignment layer 142 having no step difference may be formed through planarization of the second alignment layer 146. Accordingly, the manufacturing method of embodiments of the present invention improves (e.g., reduces) a rubbing error, and thus, reduces or prevents light leakage, thereby forming an LCD device having a high image quality.

In the manufacturing method according to yet another embodiment of the present invention, the grooves 143 are formed inside the first alignment layer 144 through the exposure, but embodiments of the present invention are not limited thereto. As an example, as illustrated in FIG. 9, the grooves 143 of FIG. 8C may be formed by etching the first alignment layer 144 through an etching process using a mask 170 (e.g., instead of the exposure mask 150). Herein, etching may be performed using dry etching, for example, plasma dry etching or reactive ion etching. The mask 170 may be a photoresist pattern. A photoresist film is formed by coating a photosensitive material on the first alignment layer 144, and thereafter the photoresist pattern may be formed through photolithography that patterns the photoresist film.

According to embodiments of the present invention, by forming the planarized alignment layer 142 having no step difference due to the pixel electrode 138 and the common electrode 140, the LCD device improves a rubbing error caused by the step difference otherwise present in an alignment layer, enhances the uniformity of alignment, and thus reduces or prevents light leakage, thereby realizing a high-quality image. According to embodiments of the present invention, moreover, provided are manufacturing methods of an LCD device having a high image quality.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A liquid crystal display (LCD) device comprising:
a substrate comprising:
a gate line;
a data line; and
a thin film transistor at a crossing region of the gate line and the data line, wherein the gate line and the data line define a pixel region;
a pixel electrode;
a common electrode separated from the pixel electrode, wherein the pixel electrode and the common electrode are alternately arranged in the pixel region; and
an alignment layer on the pixel electrode and the common electrode, between the pixel electrode and the common electrode, and in a region adjacent to the pixel electrode, wherein the alignment layer has an upper surface having a substantially uniform height.

2. The LCD device of claim 1, wherein portions of the alignment layer between the pixel electrode and the common electrode and in the region adjacent to the pixel electrode is thicker than a portion of the alignment layer on the pixel electrode and the common electrode.

3. The LCD device of claim 1, wherein a value equal to a sum of a thickness of the pixel electrode or the common electrode and a thickness of a portion of the alignment layer on the pixel electrode and the common electrode is substantially the same as a thickness of portions of the alignment layer between the pixel electrode and the common electrode and in the region adjacent to the pixel electrode.

4. The LCD device of claim 1, wherein the alignment layer comprises:
a first alignment layer comprising separated grooves; and
a second alignment layer on the first alignment layer and the pixel electrode and the common electrode, wherein the pixel electrode and the common electrode are alternately placed in the grooves.

5. The LCD device of claim 4, wherein the first alignment layer has a thickness substantially the same as the pixel electrode and the common electrode.

6. A manufacturing method of a liquid crystal display (LCD) device, the manufacturing method comprising:
preparing a substrate comprising:
a gate line;
a data line; and
a thin film transistor at a crossing region of the gate line and data line, wherein the gate line and the data line define a pixel region;
forming a pixel electrode and a common electrode t hat are separated and alternately arranged in the pixel region; and
forming an alignment layer on the pixel electrode and the common electrode, between the pixel electrode and the common electrode, and in a region adjacent to the pixel electrode, wherein the alignment layer has an upper surface having a substantially uniform height.

7. The manufacturing method of claim 6, wherein the forming of the alignment layer comprises:
forming an initial alignment layer on the pixel electrode and the common electrode; and
planarizing the initial alignment layer.

8. The manufacturing method of claim 7, wherein the planarizing the initial alignment layer comprises planarizing through exposure or etching.

9. The manufacturing method of claim 8, wherein:
the exposure uses an exposure mask comprising:
a transmission region for transmitting light; and
a light shielding region for shielding light;
the transmission region corresponds to a convex part of the initial alignment layer; and
the light shielding region corresponds to a concave part of the initial alignment layer.

10. The manufacturing method of claim 8, wherein the etching is performed using an etchback process.

11. The manufacturing method of claim 6, wherein the forming of the alignment layer comprises:
forming a first alignment layer on the pixel electrode and the common electrode;
planarizing the first alignment layer until the pixel electrode and the common electrode are exposed; and
forming a second alignment layer on the exposed pixel electrode, the exposed common electrode, and the first alignment layer between the exposed pixel electrode and the exposed common electrode.

12. The manufacturing method of claim 11, wherein the planarizing the first alignment layer comprises planarizing using exposure or etching.

13. The manufacturing method of claim 12, wherein:
the exposure uses an exposure mask comprising:
a transmission region for transmitting light; and
one of a light shielding region for shielding light, or a semi-transmission region for partially transmitting light;
the transmission region corresponds to a convex part of the first alignment layer, and
the one of the light shielding region or the semi-transmission region correspond to a concave part of the first alignment layer.

14. The manufacturing method of claim 12, wherein the etching is performed using an etchback process.

15. A manufacturing method of a liquid crystal display (LCD) device, the manufacturing method comprising:
preparing a substrate which comprises:
a gate line;
a data line; and
a thin film transistor at a crossing region of the gate line and the data line defining a pixel region;
forming a first alignment layer on the substrate of the pixel region, the first alignment layer comprising separated grooves;
forming a pixel electrode and a common electrode alternately in the grooves;
planarizing the pixel electrode, the common electrode, and the first alignment layer; and
forming a second alignment layer on the planarized pixel electrode, the planarized common electrode, and the planarized first alignment layer.

16. The manufacturing method of claim 15, wherein the grooves are formed through exposure or etching, and have a depth that is substantially the same as a thickness of the first alignment layer.

17. The manufacturing method of claim 15, wherein the pixel electrode and the common electrode have a thickness that is substantially the same as a thickness of the first alignment layer.
